(19) United States
(12) Patent Application Publication
(10) Pub. No.: US 2014/0245412 A1
(43) Pub. Date: Aug. 28, 2014

(54) LINKING CREDENTIALS IN A TRUST MECHANISM

(71) Applicants: Robert Seidl, Konigsdorf (DE); Norbert Goetze, Eichenau (DE)

(72) Inventors: Robert Seidl, Konigsdorf (DE); Norbert Goetze, Eichenau (DE)

(73) Assignee: NOKIA SOLUTIONS AND NETWORKS OY, Espoo (FI)

(21) Appl. No.: 14/117,150

(22) PCT Filed: May 16, 2011
(86) PCT No.: PCT/EP11/57822

§ 371 Date: Nov. 12, 2013

(51) Int. Cl. H04L 29/06; H04L 9/32

(52) U.S. Cl. CPC H04L 63/08; H04L 9/32
USPC 726/7; 713/168

(57) ABSTRACT

A system is described in which a user is able to generate multiple credentials, each of which includes one or more anchor attributes. Since all credentials contain the anchor attribute(s), the user can offer credentials to a relying party even if he has lost his original secret key. In this way, if a user loses a private key used to sign a credential, then he can use a credential signed by a different private key and still have that credential accepted at a relying party that knows the first credential. Furthermore, the invention enables a user to distribute his identity over multiple identity management systems.

The invention is directed to the generation of credentials for users, for example, for use when accessing Internet based service providers.

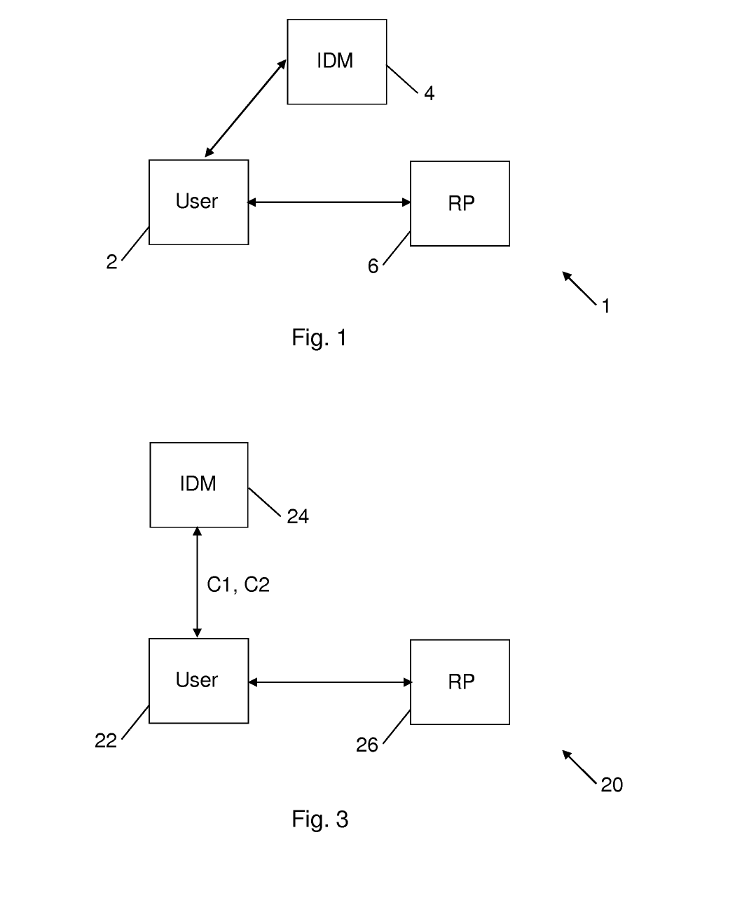

FIG. 1 is a block diagram of a system, indicated generally by the reference numeral 1, comprising a user 2, an identity management system 4 and a relying party (or receiving party) 6. The relying party 6 may, for example, be a service provider. The user 2 may take the form of a computing device (such as a PC or a laptop) or a communication device (such as a mobile communication device).

Consider the situation in which the user 2 seeks to make use of a service provided by the relying party 6 and the relying party will only provide that service if it is satisfied that a number of attributes regarding the user 2 meet certain conditions (for example, that the user is at least 18 years old or that the current location of the user is within a defined area). As is well known in the art, the user 2 can make use of the identity management system 4 to attest that a number of attributes concerning the user 2 are valid.

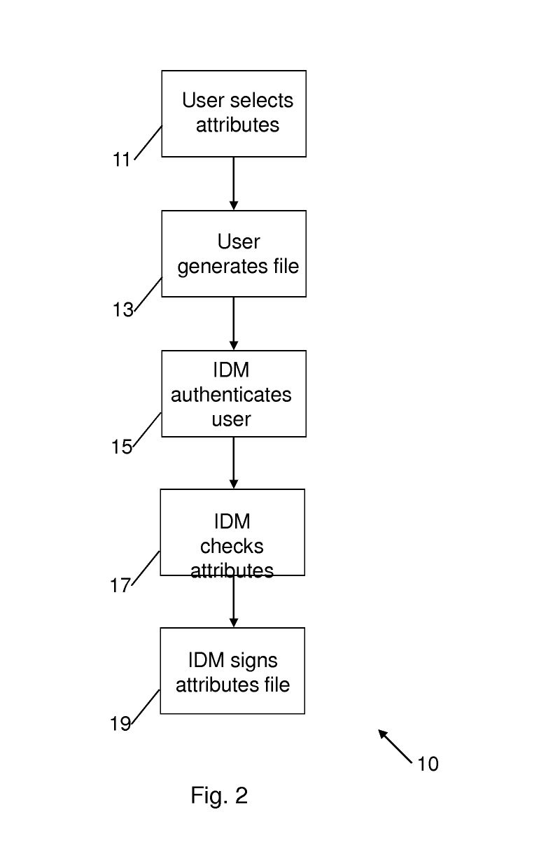

FIG. 2 is a flow chart showing an algorithm, indicated generally by the reference numeral 10, showing how the system 1 may be used.

The algorithm 10 starts at step 11. At step 11, the user 2 selects a number of attributes that the user wants the IDM system 4 to attest (the attributes A1, A2 and A3 in the example given below). In this case, the user 2 generates a file (or some other content) including these attributes. The user adds his public key to the data (UserPK1 in the example given below).

Thus, steps 11 and 13 involve the user 2 sending the following message to the IDM system 4:

[A1+A2+A3+UserPK1]where:

A1, A2 and A3 are the attributes that the IDM system 4 is being asked to attest; and

UserPK1 is the public key of the user 2.

Thus, the message includes the attributes A1, A2 and A3 and the public key of the user, all of which are sent in unencrypted form.

At step 15 of the algorithm 10, the IDM system 4 authenticates the user 2 in some way, e.g. via smart card, username/password, MSISDN, etc. Many such methods are known in the art. The attributes A1, A2 and A3 are provided in unencrypted form; therefore, the IDM system 4 can readily check those attributes against attribute values stored by the IDM (step 17 of the algorithm 10) in a manner well known in the art.

If the IDM system 4 is able to confirm that the attributes provided by the user 2 are valid, the IDM System checks the signature of the user, stores the public key (UserPK1), adds its own public key (IDMPK1) and signs at least a portion of the packet with its own private secret key (step 19 of the algorithm 10).

The result is then transported back to the user in a credential that might typically have the following form:

M+[H(M)]_{IDMSK1}

where:

M=A1+A2+A3+UserPK1+IDMPK1;

UserPK1 is the public key of the user 2;

IDMPK1 is the public key of the IDM 4;

IDMSK1 is the secret (private) key of the IDM 4; and

[H(M)]_{IDMSK1} represents the ‘signature’ of IDM1 and is the hash of M that has subsequently been encrypted by the secret key of the IDM

The user can now use the credential described above to gain access to services of relying parties (RP) such as the relying party 6.

On receipt of the credential, a relying (or receiving) party (such as the RP 6) is provided with the attributes A1, A2 and A3, the public key of the user (UserPK1) and the public key of the IDM (IDMPK1) since those data elements are included within the message M that is sent in unencrypted form. In addition, the relying party can decrypt the encrypted portion of the message (which is signed using the private key of the IDM) using the public key of the IDM.

The decrypted message is the hash of the message M. The relying party can apply the same hashing function to the message M to determine whether the hash of the message M matches the decrypted portion of the message. If it does, then the relying party can be satisfied that the message has not been changed since the hash function was generated by the IDM 4.

Thus, provided the relying party trusts the attestation provided by the IDM system 4, the relying party can be confident of the validity of the attributes provided in the credential.

A problem arises if the user 2 loses his secret key (UserSK1). In such circumstances, the user will generally obtain a new secret key (UserSK2). When interacting with the relying party 6, the user 2 will now use UserSK2. However, the relying party 6 will have stored the credential described above, which makes use of the first secret key (UserSK1). Normally the relying party will reject any credentials based on private keys that the user no longer possesses.

In order to be able to access the services at the relying party again, the user 2 would normally apply for a new credential using his new key (UserSK2) and provide the new credential to the relying party. Re-applying for credentials involves many problems, not least that the IDM providing the credential must be online, the IDM must have knowledge of the relevant attributes that the user wishes to be certified, the user must have knowledge of which IDM stores which attributes, and the user may be required to actively take part in the process of obtaining a new credential.

A further problem with known certification schemes relates to privacy. Users are becoming more concerned about their privacy and, as a logical consequence, are tending not to store all their data in one place, thereby reducing the risks associated with transparency. This tendency can result in a user being forced to offer multiple credentials to a relying party if a single IDM does not contain data concerning all attributes required by a relying party.

The present invention seeks to address at least some of the problems outlined above.

The present invention provides a method comprising obtaining (typically at/by a user device) one or more credentials from one or more identity providers, wherein each credential includes one or more attributes of a user that are attested to (i.e. declared to be correct or genuine) by one of the one or more identity providers, wherein said attributes include one or more attributes (typically referred to herein as “anchor attributes”) that are sufficient to uniquely identify the user. Exemplary anchor attributes includes, but are not limited to, an identity number, a passport number, a social security number, biometric data etc.

The user is typically a human user using a user device (such as a mobile communication device), but this is not essential to all forms of the invention. For example, the user could be a machine or some other device (such as a car, a medical device, a SIM card etc.)

In some forms of the invention, two or more credentials are obtained from the same identity provider. At least some of said two or more credentials may include the same attributes attested by the said identity provider. Obtaining two credentials enables credentials to be used, even if a private key is lost. Obtaining multiple credentials also enables attributes to be split between different credentials (thereby aiding user privacy and providing the user with a degree of control over the release of different attributes to third parties).

In some forms of the invention, two or more credentials are obtained from different identity providers. Obtaining credentials from different identity providers enables a user to choose where particular attributes should be stored, i.e. different attributes can be stored at different identity providers, if the user chooses to do so.

Where two or more credentials are obtained, at least some of said two or more credentials may include different attributes attested to by the relevant identity provider (may be by the same identity provider or by different identity providers).

The use of different attributes may enable attributes to be aggregated at a service provider. The use of different attributes may also allow the user to select which attributes are provided to a service provider (based on the selection of which credential(s) to provide).

Where two or more credentials are obtained, each of said credentials may include the same attribute (anchor attribute) that is sufficient to uniquely identify said user.

In some forms of the invention, the attribute sufficient to uniquely identify said user is a pseudonym. Further, the pseudonym may be attested to in some, but not all, of a plurality of credentials obtained by a user. Thus, the pseudonym may be attested by one identity provider and may be inserted into other credentials as an unattested attribute. A credential including an unattested pseudonym can then be linked with the credential including the attested pseudonym.

The present invention also provides an apparatus (typically a user device) comprising an input for receiving (or a means for obtaining) one or more credentials from one or more identity providers, wherein each credential includes one or more attributes that are attested to by one of one or more identity providers, wherein said attributes include one or more attributes (typically referred to herein as “anchor attributes”) that are sufficient to uniquely identify a user (e.g. a person or a machine).

In some forms of the invention, two or more credentials are obtained from the same identity provider. In other forms of the invention, two or more credentials are obtained from different identity providers.

Obtaining two or more credentials may enable credentials to be used even if a private key is lost. Obtaining multiple credentials also enables attributes to be split between different credentials (thereby aiding user privacy and providing the user with a degree of control over the release of different attributes to third parties).

At least some of said two or more credentials may include the same attributes attested by the said identity provider.

At least some of said two or more credentials may include different attributes attested to by the relevant identity provider (these may be by the same identity provider or by different identity providers).

The use of different attributes can enable attributes to be aggregated at a service provider. The use of different attributes can also allow the user to select which attributes are provided to a service provider (based on the selection of which credential(s) to provide).

In some forms of the invention, each of said credentials includes the same attribute (anchor attribute) that is sufficient to uniquely identify said user.

The attribute sufficient to uniquely identify said user may be a pseudonym. The said pseudonym may be attested to in some, but not all, of a plurality of credentials obtained by a user. Thus, the pseudonym may be attested by one identity provider and may be inserted into other credentials as an unattested attribute. A credential including an unattested pseudonym can then be linked with the credential including the attested pseudonym.

The present invention further provides a method comprising receiving one or more credentials from a user (e.g. a person or a machine), wherein each credential includes one or more attributes that are attested to (e.g. declared to be correct or genuine) by one of one or more identity provides, wherein said attributes include one or more attributes (typically referred to herein as an “anchor attribute”) that are sufficient to uniquely identify said user. The method may further comprise aggregating a plurality of attributes obtained from different credentials provided by the user.

The present invention yet further provides an apparatus (such as a relying party or a service provider) comprising means for receiving one or more credentials from a user (e.g. a person or a machine), wherein each credential includes one or more attributes that are attested to (e.g. declared to be correct or genuine) by one of one or more identity provides, wherein said attributes include one or more attributes (typically referred to herein as “anchor attributes”) that are sufficient to uniquely identify said user. A mechanism may be provided for aggregating a plurality of attributes obtained from different credentials provided by the user.

In some forms of the invention, two or more credentials may be received which were provided by (or obtained from) the same identity provider. Alternatively, or in addition, two or more credentials may be received which were provided by (or obtained from) different identity providers. Obtaining credentials from different identity providers enables a user to choose where particular attributes should be stored, i.e. different attributes can be stored at different identity providers, if the user chooses to do so.

At least some credentials may include different attributes attested to by the relevant identity provider (may be by the same identity provider or by different identity providers).

The use of different attributes can enable attributes to be aggregated at a service provider. The use of different attributes may allow the user to select which attributes are provided to a service provider (based on the selection of which credential(s) to provide).

Each of said credentials may includes the same attribute (anchor attribute) that is sufficient to uniquely identify said user.

In some forms of the invention, the attribute sufficient to uniquely identify said user is a pseudonym. The said pseudonym may be attested to in some, but not all, of a plurality of credentials obtained by a user. Thus, the pseudonym may be attested by one identity provider and may be inserted into other credentials as an unattested attribute. A credential including an unattested pseudonym can then be linked with the credential including the attested pseudonym.

The present invention also provides a data structure (e.g. a credential) comprising: a message portion, wherein the message portion includes a number of user attributes included in unencrypted form, wherein the attributes includes at least one (anchor) attribute sufficient to uniquely identify the user; and an encrypted portion, wherein the encrypted portion includes a version of the message portion encrypted using a private key of an identity provider used to attest to the attributes included in the message portion. The encrypted portion may be a hash of the message that is subsequently encrypted using the private key of the identity provider. The message portion may include the public key of the identity provider. The message portion may include the public key of the user. The user may be a person, but this is not essential to all forms of the invention.

The present invention further provides a computer program comprising code (or some of means) for obtaining (at a user device) one or more credentials from one or more identity providers, wherein each credential includes one or more attributes of a user that are attested to (e.g. declared to be correct or genuine) by one of the one or more identity providers, wherein said attributes (such as anchor attributes) include one or more attributes that are sufficient to uniquely identify the user. The computer program may be a computer program product comprising a computer-readable medium bearing computer program code embodied therein for use with a computer.

The present invention yet further provides a computer program comprising code (or some other means) for receiving one or more credentials from a user, wherein each credential includes one or more attributes that are attested to (e.g. declared to be correct or genuine) by one of one or more identity providers, wherein said attributes include one or more attributes (such as anchor attributes) that are sufficient to uniquely identify said user. The computer program may be a computer program product comprising a computer-readable medium bearing computer program code embodied therein for use with a computer.

Exemplary embodiments of the invention are described below, by way of example only, with reference to the following numbered drawings.

FIG. 1 is a block diagram of a known system;

FIG. 2 is a flow chart showing an exemplary use of the system of FIG. 1;

FIG. 3 is a block diagram of a system in accordance with an aspect of the present invention;

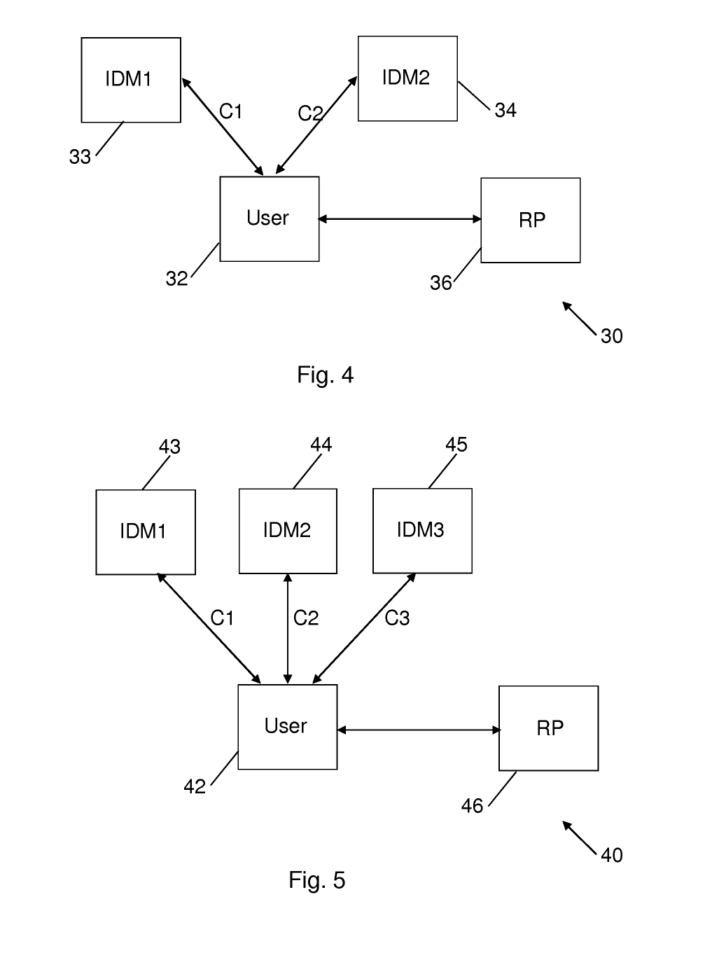

FIG. 4 is a block diagram of a system in accordance with an aspect of the present invention;

FIG. 5 is a block diagram of a system in accordance with an aspect of the present invention; and

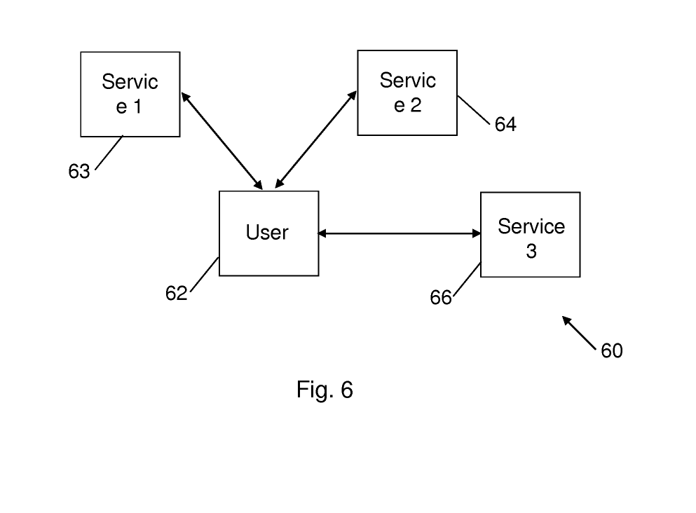

FIG. 6 is a block diagram of a system in accordance with an aspect of the present invention.

The present invention makes use of an enhanced identity management (IDM) system to sign credentials which the user can offer to a relying (or receiving) party (RP) even when the IDM is offline.

In one embodiment of the invention, an IDM system is provided that will only sign the credentials if the following conditions are met:
1. The user is authorized to post the request;
2. The user is authenticated by the IDM system;
3. The credential contains attributes of which the IDM system is knowledgeable or which the IDM system can verify;
4. At least one of the attributes presented to the IDM system is an anchor attribute which uniquely identify the user (such as an ID-number, passport number, social security number etc.); and
5. The values of the anchor attribute(s) match to the values in the IDM database.

The IDM system marks or certifies the attributes of the users prior to signing the credential. Therefore the relying parties get an indication of which attributes are being attested to by the IDM system. Such a marking may be implemented in any of a number of ways. For example, the IDM may provide a document including a header, wherein the header indicates which of the attributes included have been certified by the IDM system.

Since all credentials contain the anchor attribute(s), the user can offer credentials to a relying party even if he has lost his original secret key. Moreover, the user can offer credentials to a received party signed by different IDM systems.

FIG. 3 is a block diagram of a system, indicated generally by the reference numeral 20, in accordance with an aspect of the present invention. The system 20 comprises a user 22, an identity management (IDM) system 24 and a relying party (RP) 26. As shown in FIG. 3, the user 22 is in two-way communication with both the IDM system 24 and the relying party 26. The system 20 is the same as the system 1 described above, but is used in a different manner, as described in detail below.

Consider the situation where the user 22 obtains a first credential (C1) and a second credential (C2) from the IDM 24. The first and second credentials both include a number of attributes that are checked by the IDM 24 before the credential is signed. Importantly, both credentials include an anchor attribute (A_{A}).

In this example:

C1=M₁+[H(M₁)]_{IDMSK1}

C2=M₂+[H(M₂)]_{IDMSK1}

where:

M₁=A1+A2+A_{A}+UserPK1+IDMPK1;

M₂=A1+A2+A_{A}+UserPK2+IDMPK1;

A1, A2 and A_{A} are the attributes that the IDM system 24 is being asked to attest;

A_{A} is an anchor attribute that uniquely identifies the user 22;

UserPK1 is the first public key of the user 22;

UserPK2 is the second public key of the user 22;

IDMPK1 is the public key of the IDM 24;

IDMSK1 is the secret (private) key of the IDM 24; and

[H(Mₓ)]_{IDMSK1} is the hash of the message Mₓ that has subsequently been encrypted by the secret key of the IDM 24.

In the examples provided above, the public keys of the user and the IDM are provided in unencrypted form, so that the message can be decrypted on receipt without any prior knowledge of the keys.

In the event that the user 22 loses his first private key (UserSK1), when the user interacts with the relying party 26, he must do so using his second key (UserSK2). When authenticating towards the relying party 26, the user 22 can either offer credential C2 (including the new key, which has not been lost) or he can offer both credentials C1 and C2 together (since the user must generally offer a credential using a public key for which he has the corresponding private key).

If the relying party 26 is provided with the first credential C1, which contains the user's first public key UserPK1 (which is different to the second public key UserPK2 that is used in communications between the user 22 and the relying party 26), the relying party must check the contents of the credentials. Since both credentials (C1 and C2) contain the same certified anchor attribute (the attribute A_{A}), and since the relying party trusts the IDM 24, the relying party can accept the first credential, despite the fact that that credential uses a different user key to that with which the user is communicating with the relying party.

Once the relying party 26 has accepted the first credential (despite being presented with the second user key, which is not included in the first credential), the relying party typically presents a cryptographic challenge to the user, based on the user's public/private key pair. In order to do so, the relying party 26 must know on which public key this challenge must be based on (such a challenge clearly should not be based on a key that has been lost by the user). The easiest implementation would be to use the most recent public key of the user which is in the most recent credential. Other arrangements will be apparent to persons skilled in the art.

In the present example, since the credentials C1 and C2 both include the same user attributes (A1, A2 and A_{A}), the user may choose to delete C1 if the private key corresponding to the public key used in C1 is lost by the user.

FIG. 3 shows a situation in which the user 22 can obtain a second credential (based on a second private key) from a single IDM system 24. Thus, if a first private key is lost, then the second credential can be used. Such a scenario does not require the IDM system to be online at the time at which the second credential becomes necessary. Also, the relying party 26 can readily accept the first credential, provided that there is an anchor attribute (or multiple anchor attributes) that corresponds with an anchor attribute of the second credential.

The system 20 as described above addressed many of the problems with the prior art system outlined above. However, the principles of the invention can be extended further, as described below.

FIG. 4 shows a system, indicated generally by the reference numeral 30, comprising a user 32, a first IDM system 33, a second IDM system 34 and a relying party 36. The user 32 is in two-way communication with the first IDM system 33, the second IDM system 34 and the relying party 36.

Consider the situation where the user 32 obtains a first credential (C1) from the first IDM 33 and a second credential (C2) from the second IDM 34. The first and second credentials both include a number of attributes that are checked by the IDMs 33 and 34 before the credential is signed. As in the system 20 described above, both credentials include an anchor attribute (A_{A}). The system 30, however, differs from the system 20 in that the two credentials are issued by two different IDMs and do not (necessarily) include the same set of attributes (although some, or indeed all, of the attributes attested in two different credentials could be the same in some embodiments of the invention).

In this example:

C1=M₁+[H(M₁)]_{IDM1SK1}

C2=M₂+[H(M₂)]_{IDM2SK1}

where:

M₁=A1+A2+A_{A}+UserPK1+IDM1PK1;

M₂=A3+A4+A_{A}+UserPK2+IDM2PK1;

A1, A2 and A_{A} are the attributes that the first IDM system 33 is being asked to attest;

A3, A4 and A_{A} are the attributes that the second IDM system 34 is being asked to attest;

A_{A} is an anchor attribute that uniquely identifies the user 32;

UserPK1 is the first public key of the user 32;

UserPK2 is the second public key of the user 32;

IDM1PK1 is the public key of the first IDM 33;

IDM1SK1 is the secret (private) key of the first IDM 33;

IDM2PK1 is the public key of the second IDM 34;

IDM2SK1 is the secret (private) key of the second IDM 34;

[H(Mₓ)]_{IDMYSK1} is the hash of the message Mₓ that has subsequently been encrypted by the secret key of an IDM Y.

Regardless of whether the user 32 is using the first key (UserSK1) or the second key (UserSK2) in communications with the relying party 36, he can use either the first credential or the second credential. This may be useful since the two credentials contain different attributes and so the credential sent can be selected depending on the requirements of the relying party (rather than depending on the keys known to the relying party). Note, however, that if one of the keys has been lost, then the user must send a credential including a user public key having a corresponding private key that is known to the user.

Thus, the system 30 not only offers different credentials that can be used in case a key is lost by the user, the system 30 also provides different credentials that can be used in different circumstances.

The use of two IDM systems (as described above with reference to FIG. 4) can be extended to the use of more than two IDM systems (as described below with reference to FIG. 5).

FIG. 5 shows a system, indicated generally by the reference numeral 40, comprising a user 42, a first IDM system 43, a second IDM system 44, a third IDM system 45 and a relying party 46. The user 42 is in two-way communication with the first IDM system 43, the second IDM system 44, the third IDM system 45 and the relying party 46.

Consider the situation where the user 42 obtains a first credential (C1) from the first IDM 43, a second credential (C2) from the second IDM 44 and a third credential (C3) from the third IDM 45. The first, second and third credentials include a number of attributes that are checked by the IDMs 43, 44 and 45 before the credential is signed. As in the systems 20 and 30 described above, the credentials include an anchor attribute (A_{A}). The system 40 is similar to the system 20 in that the various credentials do not (necessarily) include the same set of attributes (although some, or indeed all, of the attributes attested in two different credentials could be the same in some embodiments of the invention).

In this example:

C1=M₁+[H(M₁)]_{IDM1SK1}

C2=M₂+[H(M₂)]_{IDM2SK1}

C3=M₃+[H(M₃)]_{IDM3SK1}

where:

M₁=A1+A2+A_{A}+UserPK1+IDM1PK1;

M₂=A3+A4+A_{A}+UserPK1+IDM2PK1;

M₃=A5+A6+A_{A}+UserPK1+IDM3PK1;

A1, A2 and A_{A} are the attributes that the first IDM system 43 is being asked to attest;

A3, A4 and A_{A} are the attributes that the second IDM system 44 is being asked to attest;

A5, A6 and A_{A} are the attributes that the third IDM system 45 is being asked to attest;

A_{A} is an anchor attribute that uniquely identifies the user 42;

UserPK1 is the public key of the user 42;

IDM1PK1 is the public key of the first IDM 43;

IDM1SK1 is the secret (private) key of the first IDM 43;

IDM2PK1 is the public key of the second IDM 44;

IDM2SK1 is the secret (private) key of the second IDM 44;

IDM3PK1 is the public key of the third IDM 45;

IDM3SK1 is the secret (private) key of the third IDM 45;

[H(Mₓ)]_{IDMYSK1} is the hash of the message Mₓ that has subsequently been encrypted by the secret key of an IDM Y.

When the user 42 communicates with the relying party 46, he can use any of the first, second and third credentials. As in the system 30 described above, this may be useful since the three credentials contain different attributes and so the credential sent can be selected depending on the requirements of the relying party. Moreover, the user 42 can use more than one credential, in order to communicate more attributes to the relying party 46.

In the use of the system 40, the relying party 46 may receive all three credentials from the user 42. If so, the relying party 46 verifies that all three credentials (C1, C2 and C3) have been signed with the same secret key User1PK1 because of the presence of User1PK1 in all credentials. In addition, the relying party determines that different IDM systems verified the attributes. Provided that the relying party 46 trusts all three of the IDM systems, the relying party can aggregate the attributes within the three credentials, if those credentials all contain the same anchor attribute. (Of course, aggregation could also occur if the relying party receives any two of the three credentials.)

Thus, the system 40 offers different credentials that can be in different circumstances. Clearly, the system 40 can readily be extended to make use of more than three IDM systems.

It should be noted that in the system 40, each of the credentials including the same user public key (UserPK1). Clearly, as in the system 30 described above, the credentials could include different user keys. Alternatively, two keys could be used (with one key being re-used).

In the exemplary systems described above, the credentials provided by each IDM system not only all included an anchor attribute (i.e. an attribute sufficient to uniquely identify the user), they all included the same anchor attribute. This is not essential to all embodiments of the invention, as described further below.

Consider, once again, the system 30, described above with reference to FIG. 4. As described above, the user 32 obtains a first credential (C1) from the IDM 33 and a second credential (C2) from the IDM 34. The first and second credentials both include a number of attributes that are checked by the IDMs 33 and 34 before the credential is signed.

In the present example, the first credential (C1) includes one or more anchor attributes (such as the user's social security number) and also includes a pseudonym as an additional attribute. Importantly, the pseudonym is provided by the user 32 and cannot be attested by the first IDM 33 that provides the first credential.

The second credential (C2) includes the pseudonym as the anchor attribute. In this example:

C1=M₁+[H(M₁)]_{IDM1SK1}

C2=M₂+[H(M₂)]_{IDM2SK1}

where:

M₁=A1+A2+A_{AU}+UserPK1+IDM1PK1;

M₂=A3+A4+A_{AC}+UserPK1+IDM2PK1;

A1, A2 and A_{AU} are the attributes that the first IDM system 33 is being asked to attest;

A_{AU} is the uncertified anchor attribute (pseudonym) that the User adds to the content;

A3, A4 and A_{AC} are the attributes that the second IDM system 34 is being asked to attest;

A_{AC} is a certified anchor attribute (pseudonym) that the user 32 adds to the content;

UserPK1 is the public key of the user 32;

IDM1PK1 is the public key of the first IDM 33;

IDM1SK1 is the secret (private) key of the first IDM 33;

IDM2PK1 is the public key of the second IDM 34;

IDM2SK1 is the secret (private) key of the second IDM 34;

[H(Mₓ)]_{IDMYSK1} is the hash of the message Mₓ that has subsequently been encrypted by the secret key of an IDM Y.

The user 32 can offer either the first credential (C1) or the second credential (C2) to the relying party 36 (or both). If both credentials are provided, then the relying party can map the attributes of the second credential to the attributes of the first credential using the pseudonym provided in the second credential. With the first credential identified, the identity of the user can readily be determined.

The advantage of this approach is that the user can allocate all ‘sensitive’ attributes to the second IDM 34, without the second IDM being able to map the attributes to a specific user. If the first IDM 33 and the second IDM 34 do not collaborate and merge their data, the users privacy is enforced. The second IDM could, for example, be an advertising system, a games portal, a mailing system, etc. Moreover, if the relying party 36 trusts the second IDM 34 enough to offer a unique pseudonym to its users, this scenario would even work if the second certification was signed by a different private users key.

As discussed above, users are becoming more concerned about their privacy. So as logical consequence, they tend not to store all their data in one single place, thereby reducing the risks associated with being totally transparent. A problem that tends to arise as a result is that users might be forced to offer a set of credentials to a relying party if a single credential does not contain all required attributes. The following example, described with reference to FIG. 6, shows how the present invention seeks to address this problem.

FIG. 6 is a block diagram of a system, indicated generally by the reference numeral 60, in accordance with an aspect of the present invention. The system 60 comprises a user 62, a first service 63 (including a first identity management system), second service 64 (including a second identity management system) and a third service 66 (acting as a relying party). The user 62 is in two-way communication with each of the first, second and third services.

In this example, the first service 63 is provided by a dieting club that the user attends, the second service 64 is provided by the user's employer and the third service 66 is provided by a pizza delivery company.

The user 62 seeks to hide his membership of the dieting club from his employer and to hide the name of his employer from the dieting club. In order to achieve this, both the dieting club and the company sign credentials and attest to specific attributes for the same user, but neither the dieting club nor the employer would be aware of all of the attributes of the user 62.

Assume now that the pizza delivery club offers free-of charge diet pizzas if the consumer is a member of the dieting club and is working for any local company. In the system 60, the user 62 would have credentials in place to prove this.

In a first approach, the first service 63 (the dieting club) signs a first credential (C1) containing the following attributes:

A_{A1}: First Name=John

A_{A2}: Last Name=Doe

A_{A3}: Address=St. Martin Street 76, Munich, Germany

A1: Full Membership=Yes

UserPK1

IDM1PK1

In the first approach, the second server 64 (the employer) signs a second credential (C2) containing the following attributes:

A_{A1}: First Name=John

A_{A2}: Last Name=Doe

A_{A3}: Address=St. Martin Street 76, Munich, Germany

A2: Status=local staff

UserPK2

IDM2PK1

In this specific case both the first service 63 and the second server 64 can verify the correctness of the anchor attributes included in the certificates that they provide. Therefore the user can be challenged by the third service 66 to deploy either UserSK1 or UserSK2 (the secret keys corresponding to the public keys UserPK1 and UserPK2 respectively).

The issue that immediately arises is that the pizza delivery company 66 could receive the aggregated attributes and know more about the consumer than either the dieting club 63 or the employer 64. However, in this case, the consumer could use state-of-the-art ‘Zero Knowledge Prove’ technology (e.g. IDEMIX or U-Prove) to remain completely anonymous to the pizza delivery company. Such technology is well known to persons skilled in the art and, as it does not form an essential part of the present invention, will not be described further here.

An alternative to the above approach would be to provide an alias as an anchor attribute. In this case the identity of the user remains hidden to the RP (the third service 66).

In this second approach, the first service 63 (the dieting club) would provide a first credential having the following attributes:

A_{AC}: Alias=Johnny123

A1: Full Membership=Yes

UserPK1

IDM1 PK1

The second service 64 (the employer) would provide a second credential (C2) having the following attributes:

A_{AU}: Alias=Johnny123

A2: Status=local staff

UserPK2

IDM2PK1

In this example:

C1=M₁+[H(M₁)]_{IDM1SK1}

C2=M₂+[H(M₂)]_{IDM2SK1}

where:

M₁=A1+A_{AC}+UserPK1+IDM1PK1;

M₂=A2+A_{AU}+UserPK2+IDM2PK1;

A1 and A_{AC} are the attributes that the first IDM system 63 is being asked to attest;

A_{AC} is the certified anchor attribute (pseudonym) that the user 62 adds to the content;

A2 is the attribute that the second IDM system 64 is being asked to attest;

A_{AU} is a uncertified anchor attribute (pseudonym) that the user 62 adds to the content;

UserPK1 is the first public key of the user 62;

UserPK2 is the second public key of the user 62;

IDM1PK1 is the public key of the first IDM 63;

IDM1SK1 is the secret (private) key of the first IDM 63;

IDM2PK1 is the public key of the second IDM 64;

IDM2SK1 is the secret (private) key of the second IDM 64;

[H(Mₓ)]_{IDMYSK1} is the hash of the message Mₓ that has subsequently been encrypted by the secret key of an IDM Y.

In this example, the pseudonym acts as an anchor attribute, although that pseudonym can only be attested by the first service 63 (and not by the second service 64).

The first service 63 (the dieting club) guarantees that the alias Johnny123 is a unique handle of one of its members. The user John Doe can administer this alias into the database at the second service 64 (the employer). In this specific case (since the second service 64 cannot verify the correctness of Johnny123), the user must be challenged by the RP (the service 66) to deploy both UserSK1 and UserSK2. Otherwise the user could forward credentials not belonging to him.

The second approach therefore allows the user to administer the aggregation possibilities of his attributes over multiple IDM systems via anchor attributes in a privacy-respecting manner.

In the various embodiments of the invention described above, the implementation is distributed over three sites: the user, the relying party and the identity management systems. In each case:
1. The IDM(s) must authenticate the user prior to signing the credentials. Attributes which the IDM can attest are typically marked by the IDM.
2. The user inserts anchor attributes into the credentials and forwards these to the IDM system knowledgeable about these attributes.
3. The user and the relying party agree on which private key the relying party will use in a challenge or some algorithm must be provided to enable the user and the relying party to reach the same decision as to which key should be used.

The relying party must check the contents of the credentials. The relying party must then build a ‘chain of trust’ out of the contents on the credentials according to the principles described in detail above. Finally the relying party must challenge the user via a chosen user's public key(s).

The present invention has generally been described assuming that a user will be using a user device (such as a mobile communication device) to generate credentials and that the attributes included in the credentials will relate to a human user. This is not essential to all forms of the invention. For example, the “user” could be a machine or some other device (such as a car, a medical device, a SIM card etc.).

For example, a blood pressure measuring device could hold two credentials. The first credential could attest the manufacturer, the owner's certified (and unique) pseudonym (A_{Ac}), the date of purchase and the (calibration) guarantee. The second credential could attest the uploaded measurements made in the last few days together with the owner's uncertified pseudonym (A_{AU}).

An identity management system could also be used to map the identity of the devices to certified locations (SIM card X to traffic light Y located in crossing Z) and to persons (IMEI numbers of mobile phones to owners).

Moreover, the principles of the present invention need not only be provided for humans, but also for machines, animals and any other ‘things’. For example, a dog with an RFID chip in his ear might not be keen on privacy, but his owner might be concerned if other people could freely find out where his dog's home is, especially after his dog bit the neighbour's cat. So the RFID chip could contain a credential certifying the owner's pseudonym and the responsible IDM system (e.g. the local police) could be able to resolve the pseudonym to a real name and an address. Thus, the owner of the cat in this scenario would have to go to the police to trigger legal actions against the owner of the dog.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A method comprising obtaining one or more credentials from one or more identity providers, wherein each credential includes one or more attributes of a user that are attested to by one of the one or more identity providers, wherein said attributes include one or more attributes that are sufficient to uniquely identify the user.

2. A method as claimed in claim 1, further comprising obtaining two or more credentials from the same identity provider.

3. A method as claimed in claim 2, wherein at least some of said two or more credentials include at least some of the same attributes attested by the said identity provider.

4. A method as claimed in claim 1, further comprising obtaining two or more credentials from different identity providers.

5. A method as claimed in claim 2, wherein at least some of said two or more credentials include different attributes attested to by the relevant identity provider.

6. A method as claimed in claim 2, wherein each of said credentials includes the same attribute that is sufficient to uniquely identify said user.

7. A method as claimed in claim 1, wherein the attribute sufficient to uniquely identify said user is a pseudonym.

8. A method as claimed in claim 7, wherein said pseudonym is attested to in some, but not all, of a plurality of credentials obtained by a user.

9. An apparatus comprising an input for receiving one or more credentials from one or more identity providers, wherein each credential includes one or more attributes that are attested to by one of one or more identity providers, wherein said attributes include one or more attributes that are sufficient to uniquely identify a user.

10. An apparatus as claimed in claim 9, wherein at least some of said two or more credentials include different attributes attested to by the relevant identity provider.

11. An apparatus as claimed in claim 9, wherein each of said credentials includes the same attribute that is sufficient to uniquely identify said user.

12. A method comprising receiving one or more credentials from a user, wherein each credential includes one or more attributes that are attested to by one of one or more identity providers, wherein said attributes include one or more attributes that are sufficient to uniquely identify said user.

13. A method as claimed in claim 12, further comprising aggregating a plurality of attributes obtained from different credentials provided by the user.

14. An apparatus comprising an input for receiving one or more credentials from a user, wherein each credential includes one or more attributes that are attested to by one of one or more identity provides, wherein said attributes include one or more attributes that are sufficient to uniquely identify said user.

15. An apparatus as claimed in claim 14, further comprising means for aggregating a plurality of attributes obtained from different credentials provided by the user.

16. An apparatus as claimed in claim 14, wherein at least some of the credentials include different attributes attested to by the relevant identity provider.

17. An apparatus as claimed in claim 14, wherein the attribute sufficient to uniquely identify said user is a pseudonym.

18. A data structure comprising:
a message portion, wherein the message portion includes a number of user attributes included in unencrypted form, wherein the attributes includes at least one attribute sufficient to uniquely identify a user; and
an encrypted portion, wherein the encrypted portion includes a version of the message portion encrypted using a private key of an identity provider used to attest to the attributes included in the message portion.

19. A computer program product comprising means for obtaining or more credentials from one or more identity providers, wherein each credential includes one or more attributes of a user that are attested to by one of the one or more identity providers, wherein said attributes include one or more attributes that are sufficient to uniquely identify the user.

20. A computer program product comprising means for receiving one or more credentials from a user, wherein each credential includes one or more attributes that are attested to by one of one or more identity providers, wherein said attributes include one or more attributes that are sufficient to uniquely identify said user.
